(19) United States
(12) Patent Application Publication
(10) Pub. No.: US 2026/0086263 A1
(43) Pub. Date: Mar. 26, 2026

(54) PHOTOELECTRIC SENSOR WITH WELD CONNECTION BETWEEN HOUSING AND OPTICAL MODULE

(71) Applicant: ELESTA GMBH OSTFILDERN (DE) ZWEIGNIEDERLASSUNG BAD RAGAZ, Bad Ragaz (CH)

(72) Inventors: Dominik GULDIMANN, Bonaduz (CH); Joel Bernhard RITTER, Gams (CH); Sergiy MAYILO, Sargans (CH)

(21) Appl. No.: 19/128,705

(22) PCT Filed: Nov. 14, 2023
(86) PCT No.: PCT/CH2023/050036

§ 371 Date: May 9, 2025

(30) Foreign Application Priority Data
Nov. 16, 2022 (CH) CH001361/2022

(51) Int. Cl. G01V 8/20

(52) U.S. Cl. CPC G01V 8/20

(57) ABSTRACT

A photoelectric sensor, in particular a light curtain, is shown, including an elongated housing and an optical module arranged in the housing. Transmitting and/or receiving elements are arranged at a distance from one another on the optical module, and the optical module is connected to the housing via contact points, wherein the contact points are flat. The optical module and the housing are made of plastic. At least some of the contact points are designed as welded connections, with the housing and the optical module being welded together.

### TECHNICAL FIELD OF THE INVENTION

The invention relates to a photoelectric sensor according to the generic part of claim 1 and a method for manufacturing a photoelectric sensor according to claim 28.

### BACKGROUND TO THE INVENTION

State-of-the-art photoelectric sensors usually have an aluminum profile in which at least one optics module is arranged. The optical module comprises the components that ensure the function of a photoelectric sensor. In addition to the transmitting and/or receiving elements on a printed circuit board, the supporting body for the printed circuit board, also known as the tube, is usually a part of the optical module. The optics module may additionally comprise aperture and lens assemblies, depending on the design, with these assemblies preferably being attached to the supporting body. The aluminum profile has one or more openings along one longitudinal side. The optical modules are arranged in the aluminum profile in such a way that the transmitting or receiving elements of the optical modules are directed towards the longitudinal side with the openings. A plastic strip is provided to be attached to the aluminum profile as a protective screen, which is transparent to the wavelength emitted by the optical modules. The protective screen can be attached to the aluminum profile either permanently or detachably. However, the resulting connection of two different materials forms a mechanical weak point and requires an additional step in the production of the photoelectric sensor. At the same time, the connection must be sealed so well that the optical module is protected against splashes.

The optical module is arranged in the aluminum profile using guides on the inside of the profile that run in the longitudinal direction of the profile. The opposing elements of the optical modules can be inserted into these guides, creating a form-fitting and/or force-fitting connection between the optical module and the aluminum profile. With this type of connection, a decision must be made as to whether ease of assembly or high vibration and shock resistance is to be prioritized. However, the two requirements are contradictory.

Instead of an aluminum profile, the profile can also be made of a different material, such as plastic. The way the connection is made with the optical module is the same for plastic profiles as it is for aluminum profiles, and therefore, with regard to the stability of this connection against oscillation and shock movements, it presents the same problems as for aluminum profiles.

US 2013/292554 A1 shows a light curtain with an optical module that is designed to be inexpensive to manufacture and easy to set up. The optical module is designed to be mounted in a U-shaped profile. It has protruding elements that are used to position the optical module precisely within the housing. In addition, the optical module can have fasteners that are used to fasten the optical module within the housing. The fasteners are preferably designed as snap-in elements. The fasteners can be firmly attached to the housing. Adhesive bonding, ultrasonic welding or screw fastenings are used for this purpose.

EP 1 770 414 A1 describes an optoelectronic arrangement with a plurality of light emitter or light receiver modules that are electrically connected to each other by means of a flexible printed circuit board and associated with a tube or lens body. The light emitter or light receiver modules are attached directly to the tubes or lens bodies to which they are assigned, and the flexible light guide is fastened directly to the light emitter or light receiver modules. A plastic housing is provided to accommodate the light emitter or light receiver modules, which is attached to the tube using snap-fit elements. In addition, the light emitter or light receiver modules can be connected to the respectively assigned tubes or lens bodies by means of a welded connection. The tube can be mounted in a housing, wherein the housing has grooves for this purpose, via which the tube can be fixed.

It is known from patent EP2730952A1 that individual housing modules can be combined to build light curtains with different protective field heights from a uniform, short base module. The disadvantage of this variant is that each connection point contains an electrical transition that must be sealed against environmental influences. Furthermore, the mechanical stability of this connection is limited, which is why only a few housing modules can be combined and the maximum protective field height of a light curtain built in this way is limited.

From patent US 2014/346318, it is known that a printed circuit board equipped with spacers can be aligned with a tube pinhole aperture so that the axis of the optoelectronic components (LED/lens) exactly matches the axis of the pinhole aperture. The printed circuit board can then be fixed in position by means of a laser welded connection between the spacer elements and the tube. The disadvantage of this variant is that for each light beam in a light curtain, the optoelectronic component has to be aligned with the corresponding pinhole aperture and fixed in place by laser welding. This is very time-consuming and costly. In addition, each light beam requires two distance elements, which are needed for the laser welded connection. This also leads to high manufacturing costs.

### TASK

The purpose of this invention is therefore to propose an alternative photoelectric sensor, in particular a light curtain, with a simple and cost-effective way of connecting the optical modules to the housing, which has an increased vibration and shock resistance and can be produced with minimal mechanical stress on the optical modules and the housing. Furthermore, the sealing of the housing should be as effective as possible.

### DESCRIPTION

The problem is solved by a photoelectric sensor with the features of claim 1.

The photoelectric sensor, in particular a light curtain, comprises an elongated housing and an optical module that is arranged in the housing. Transmitting and/or receiving elements are arranged at a distance from one another on the optics module, and the optics module is connected to the housing via contact points, wherein the contact points are flat. The optical module and the housing are made of plastic. At least some of the contact points are designed as welded connections, with the housing being welded to the optical module. The welded connection between the housing and the optical module is formed by laser penetration welding.

The housing serves to protect the optical module of the photoelectric sensor from external influences and as a stabilizing element. The welded connection provides a firm connection between the housing and the optical module inside it. The advantage of this is that the optical modules are first positioned by inserting them into the housing and then firmly connected to the housing in a second step.

This not only simplifies the assembly process but also creates a firm connection between the two components of the photoelectric sensor, significantly increasing its resistance to vibration and shock.

The housing can be described as an appliance housing, because it is used to accommodate an optical module, so that the optical module is completely enclosed by the housing. It is therefore intended that the optical module be completely enclosed by the housing in the peripheral direction.

Since the components are in contact at the contact points, an increase in temperature of one of the two components will cause the other component to heat up as well. In this process, the temperature of the material at the irradiated points is increased up to its melting temperature. As a result, the material of both components melts at the irradiated contact point, and after cooling, a permanent bond is formed. In this case, the process is referred to as laser transmission welding.

Compared to the ultrasonic welding method, laser penetration welding has the advantage that the energy can be applied to the welding point without contact. Irradiating a contact point with a laser beam from the outside is enough to create a strong welded connection. For comparison, in an ultrasonic welding method, the sonotrode intended for this purpose is used to generate the ultrasonic waves in contact with the component to be welded. Therefore, the components to be welded, i.e., the joining partners, are subjected to a high joining force during the welding process. In contrast, in the case of laser transmission welding, the energy for creating the connection between the components or for welding both components is introduced without contact.

The advantage of the non-contact connection is that no external pressure is applied to the joint. This also allows contact points to be welded that do not offer the possibility of absorbing the joining force of an ultrasonic welding sonotrode, or are located in a closed system. Furthermore, there is no risk of the parts to be joined shifting out of alignment due to the joining force applied.

The simple design of the housing and the use of plastic for the main components of the photoelectric sensor keep manufacturing costs low. The cost of acquiring plastic is comparatively low.

In a preferred embodiment, at least in the region of the contact points, either the housing is transparent to infrared rays and the optical module absorbs infrared rays, or the housing absorbs infrared rays and the optical module is transparent to infrared rays. The contact points arise from the contact points or contact surfaces between the housing and the optical module. If one of the two components absorbs infrared rays in the region of the contact point, this leads to a local temperature increase when the contact point is irradiated with infrared laser beams. In the manufacturing process, this goes so far that the plastic material melts at the irradiated point.

Advantageously, the contact points of the optical module and the housing each comprise a mutually compatible plastic, in particular thermoplastics, even more preferably polycarbonate. In the context of the present invention, “compatible” means that the plastics can be joined to one another by laser welding. By melting the plastic materials of the two components, a particularly resistant welded connection can be created. If identical plastic materials are used, the optical module and the housing will experience the same thermal expansion during the welding process and also later during operation due to the identical temperature expansion coefficients, so that no stresses arise in the welding points due to temperature expansion.

In a further preferred embodiment, the plastic material of at least one of the two components is mixed with an infrared-ray-absorbing additive at the intended contact points of the optical module with the housing. The infrared-absorbing material is distributed evenly throughout the plastic. Mixing the plastic with such an additive eliminates the need for an additional step after the components have been manufactured, since the additive is already integrated into the plastic at the contact points.

In another preferred embodiment, the optics module comprises a supporting body on which a printed circuit board with the transmitting and receiving elements is arranged. Thus, the transmitting and receiving elements are arranged on a printed circuit board, with the supporting body, as a component of the optical module, having the task, among other things, of holding the printed circuit board. The printed circuit board can be connected to the supporting body in a form-fitting or force-fitting manner. It is also conceivable that a printed circuit board is arranged on several supporting bodies.

The supporting body and the housing are advantageously made of a compatible thermoplastic. Thus, a welded connection can be made between the housing and the supporting body. In this design, the supporting body is the part of the optical module that is made of a thermoplastic material that is compatible with the housing. The welded connection between the housing and the supporting body allows the use of a modular optical module design. Other assemblies that may be included as components of the optical module may have other functions without having to fulfill the requirement of being made of a compatible plastic.

Such further assemblies may include, inter alia, a lens assembly or an aperture assembly. Preferably, lens and/or aperture assemblies are provided on the supporting body opposite the transmitting or receiving elements. The lens assembly comprises, inter alia, lenses whose function is to disperse or to concentrate the incoming or outgoing beams. The aperture assembly is used to limit the amount of light that the transmitting elements transmitting or the receiving elements receive. The aperture assembly ensures the resolution of the safety light curtain. The resolution of the safety light curtain determines the size of the smallest detectable object. Since the optical module may comprise aperture and lens assembly, the welded connection between the optical module and the housing may also be made through the aperture and/or lens assembly.

It is conceivable that two supporting bodies in contact at the front are connected via a lens or aperture assembly. For example, the aperture assembly can have positioning lugs on the side facing the supporting body, which can be inserted vertically into recesses provided on both supporting bodies.

Preferably, at least the supporting body and the housing are made of polycarbonate. Polycarbonate has a higher impact strength than alternative plastics such as PM MA.

It is useful for the transmitting elements to comprise light-emitting diodes and the receiving elements to comprise photodiodes. Light-emitting diodes and photodiodes are widely available.

The housing is preferably cylindrical, in particular a circular cylinder. The surfaces at the ends of a circular cylindrical housing are annular and the inner wall of a circular cylindrical housing is formed by a circular cylindrical surface, thus allowing an interference fit to close the openings at the ends of the circular cylindrical housing.

The housing preferably has a closed cross-section. This means that the housing has no joints or transitions between two components or semi-finished products in the peripheral direction. Alternatively, it can also be said that the lateral surface of the housing is in one piece. This eliminates the need for a sealing element and increases the stability of the housing.

The design of the housing with a closed cross-section, in combination with the creation of the connection between the housing and the optical module by laser penetration welding, results in a controlled introduction of heat to form the welded connection. Laser penetration welding makes it possible to weld the optical modules to the housing, wherein a housing that is closed on all sides is used. With another welding method, such as the ultrasonic welding method, an open housing (U-profile) would be necessary. This is because in ultrasonic welding, energy is transferred via vibrations and the components to be welded must be firmly clamped. Since the optics module cannot be clamped in a closed housing, the optics module would be vibrated during ultrasonic welding. This in turn precludes the controlled introduction of heat to form a welded connection between the housing and the optical module. For this reason, the formation of a welded connection between the housing and the optical module by laser transmission welding cannot simply be replaced by ultrasonic welding. In addition, a closed housing eliminates the need for a further connection point between two housing parts, which would otherwise have to be connected and sealed.

In a further preferred embodiment, the housing comprises an elongated base body forming a receiving space for the optics module, with at least one opening on a longitudinal side and a protective screen closing this opening. This is an alternative design to the cylindrical housing described above. The optics module can be inserted through the opening on the longitudinal side or through the openings on the longitudinal ends. The connection between the elongated base body and the protective screen can be both fixed, i.e., inseparable, and detachable. The protective screen is designed to allow the electromagnetic radiation of the photoelectric sensor's transmitting and receiving elements to pass through.

The base body is preferably a U-profile with an opening on one longitudinal side. The U-profile is characterized by the combination of a stable form with low material costs and a large capacity. This makes it a good choice for use as a base body for the housing. Furthermore, the U-profile simplifies the assembly of the optical modules, since it is open on one longitudinal side.

The protective screen is advantageously welded to the base body at the edge, preferably by laser transmission welding. The welded connection creates a strong connection between the base body and the protective screens, and preferably forms a watertight seal between these components at the edge of the protective screens to meet the IPX 5, IPX 7, and IPX 9K protection ratings. In addition, laser transmission welding can help to increase production speed and at the same time reduce manufacturing costs, for example by eliminating the need for an additional sealing element such as an O-ring, adhesive, adhesive tape, etc.

In another preferred embodiment, end caps are attached to both open longitudinal ends of the housing. The end caps are used to close the openings at the longitudinal ends.

The end caps are advantageously made at least partially from an infrared-absorbing plastic. Thus, the end caps can also be connected to the housing or the optical module by means of laser penetration welding. As a result, the inside of the housing is splashproof. The end caps are preferably firmly attached to the housing and/or the optical module. The material-locking connection creates a robust connection between the end caps and the housing or the optical module. The material bond between the end caps and the housing and/or the optical module is preferably produced by laser transmission welding. The end caps are advantageously attached to the housing or to the optical module by means of laser penetration welding. For a laser penetration weld between the end caps and the housing or optics module, either the end caps, the housing, or the optics module must absorb infrared rays at least at the contact surfaces.

Another advantage is that the laser welding method can also be used to create a welded connection around the entire periphery of the housing, including on the front side of the housing. Lengths of almost 2 meters are common for light curtains. With such dimensions, it would not be possible to measure the joining force of an ultrasonic welded connection through the components, or only with a great deal of effort.

The end caps close the two openings on the sensor housing that are opposite each other. Preferably, the connection, especially the weld, between the end caps and the housing forms a seal. It is conceivable that the end caps have a ring shoulder that projects into the interior of the housing and whose outer diameter corresponds to the inner diameter of the housing. This allows the end caps to be connected to the housing over the entire periphery, creating a welded connection that ensures protection against splashing water. This type of connection has the advantage that an additional seal between the housing and the end caps is not necessary. The proposed welded connection thus prevents the penetration of moisture, especially if the photoelectric sensor is exposed to different temperatures during use. This type of connection is also suitable for higher ingress protection classes such as IP69K.

In another preferred embodiment, two or more optical modules can be coupled to one another at the front. This has the advantage that sensor assemblies with different protective field heights can be manufactured. The sensor housing can therefore be several times the length of a single optical module.

Preferably, the transmitting and/or receiving elements of all optical modules in the housing are directed in the same radial direction of the cylindrical housing. For light curtains, it is important that all the beams of the photoelectric sensor are exactly parallel to ensure that the light curtain can be aligned as well as possible.

In another preferred embodiment, the optics module has a first plug-in connection at one longitudinal end and a second plug-in connection at the opposite longitudinal end, wherein the first and second plug-in connections can be coupled to one another. It is important that the plug-in connection between two optical modules ensures precise mutual alignment with as little play as possible, and that the optical modules cannot twist around their longitudinal axis so that the beam axes of the optical modules are aligned in parallel.

Preferably, the first plug-in connection is designed as a plug (male) and the second plug-in connection as a socket (female). The plug-and-socket connection is a reliable and cost-effective way to couple two or more optical modules.

The end cap preferably has a plug-in connection that can be coupled to the plug-in connection of the end optical module. This prevents the relative rotation between the optical module and the adjacent end cap around the longitudinal axis of the housing. Due to the coupling of the end cap with the optical module, the alignment of the optical module can be carried out before welding by turning the coupled end cap. The end cap can, for example, have a positioning marking that defines the welding position of the optical module in the machine holder or with which the correct welding position of the optical module can be easily determined optically by an expert.

In another preferred embodiment, the photoelectric sensor comprises a mounting assembly for fastening the photoelectric sensor to a substrate. The mounting assembly is advantageously connected to the housing of the photoelectric sensor by laser penetration welding, which in turn leads to low production costs.

Another aspect of the invention relates to a photoelectric sensor, in particular a light curtain, which has an elongated housing and at least two optical modules arranged therein. The photoelectric sensor is characterized in that the optical modules can be coupled to one another at the front end by means of a plug-in connection, the optical modules having a plug at the first longitudinal end and a socket at the second end. The plug and socket of the optical modules are shaped and placed in such a way that the plug of a first optical module can be inserted into the socket of a second optical module, thus preventing a relative rotation of an optical module around the longitudinal axis. This type of plug-in connection between two optical modules ensures that these optical modules are always aligned in the same way after coupling.

Another aspect of the invention relates to a method for manufacturing a photoelectric sensor comprising an elongated housing and an optical module, wherein the optical module is inserted into the housing, aligned therein and then joined thereto by laser transmission welding. Transmitting and/or receiving elements are arranged on the optical module and the photoelectric sensor is preferably used to form a light curtain. Ideally, the elongated housing has an opening at least one longitudinal end through which the optical module can be inserted into the housing. The optics module is aligned in the housing so that the transmitting and/or receiving elements on the optics module point in the desired direction. The optical module must be in contact with the housing for laser transmission welding to be used. The contact points between the housing and the optical module serve as welding points.

The housing has an opening at least at one longitudinal end. The optical module is preferably inserted through the open longitudinal end of the housing. By using the open longitudinal end, there is no need for further openings in the housing, which ensures greater dimensional stability of the housing.

The opening at the longitudinal end of the housing forms a surface that is as small as possible and can be closed relatively easily due to its position at the end of the housing. Preferably, the opening at the longitudinal end of the housing is closed with an end cap after the optical module has been inserted into the housing.

The end cap should seal the housing to protect the optical module inside from external environmental influences. The end cap can be welded to the housing or the optical module, preferably using laser transmission welding. The welded connection between the end cap and the housing forms a seal, eliminating the need for a separate sealing component. This allows the end cap to be connected to the housing or the optical module in the same way as the optical module is already connected to the housing, thus simplifying the production process and reducing costs.

After inserting the optical module into the housing, it must be ensured that the optical module is centered in the housing. Supporting arms on the optical module can be used for this. The optical module preferably has supporting arms which, when inserted into the housing, are in contact with the housing and center the optical module in the housing.

### BRIEF DESCRIPTION OF THE FIGURES

The invention is described in more detail below with reference to the figures in a schematic presentation. Preferential features mentioned can be realized in any combination—for as long as they are not mutually exclusive. It shows in a non-scale, schematic representation:

FIG. 1: a three-dimensional partial view of a first photoelectric sensor according to the invention, consisting of a housing and an optical module arranged therein;

FIG. 2: a longitudinal section through the photoelectric sensor of FIG. 1;

FIG. 3: a perspective view of the first photoelectric sensor, in which the opposing openings of the housing are closed with end caps;

FIG. 4: a front view of the first photoelectric sensor with the end cap removed;

FIG. 5: a perspective view of several optical modules arranged in a row;

FIG. 6: a perspective view of a second photoelectric sensor with a two-part housing.

### DETAILED DESCRIPTION OF THE FIGURES

Hereinafter, the same reference symbols represent the same or functionally identical elements (in different figures). An additional apostrophe can serve to distinguish similar or functionally equivalent or functionally similar elements in a further embodiment.

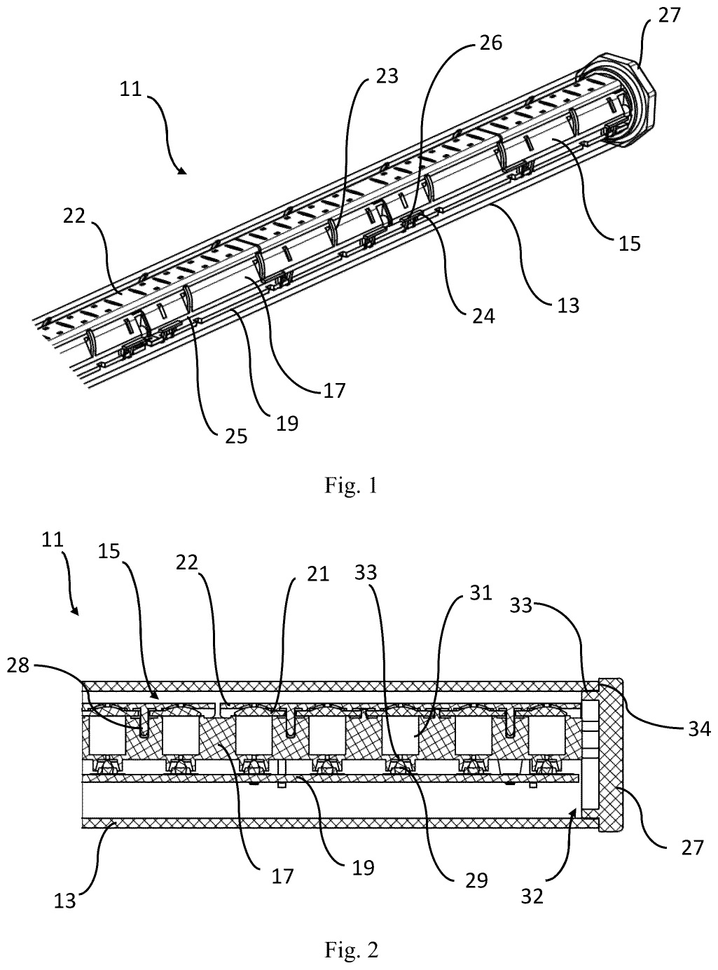

FIG. 1 shows a photoelectric sensor 11 according to the invention. The photoelectric sensor 11 comprises a housing 13 and an optical module 15, on which a printed circuit board 19 with light sources or light sensors is arranged. In the example shown, the housing 13 is transparent and formed by a hollow cylinder. The length of the cylindrical housing 13 is many times greater than its diameter. The optical module 15 is placed inside the housing 13. The optical module 15 comprises a supporting body 17, a lens assembly 21, a printed circuit board 19 and an aperture assembly 22, the lens assembly not being visible in this view. The lens assembly 21 and the aperture assembly 22 are arranged on the same longitudinal side of the supporting body, while the printed circuit board 19 is arranged on the opposite longitudinal side of the supporting body 17.

The printed circuit board 19 and the aperture assembly 21 are not in contact with the housing 13 in the design shown. It is conceivable that the connection between the optical module 15 and the housing 13 is created by the lens assembly 21, the aperture assembly 22 or a component specially introduced for this purpose.

The supporting body 17 has projections 26 on its longitudinal sides 25, which extend as far as the housing 13 and create a contact point with it. In the illustrated embodiment, the supporting body 17 has three contact points 24 per longitudinal side. These contact points 24 serve as welding points to connect the supporting body 17 to the housing 13.

Supporting arms 23 are attached to the length of optics module 15 at regular or irregular intervals. Supporting arms 23 are used to position the optical module 15 within the housing 13. Supporting arms 23 project vertically from the respective longitudinal side 25 so that they are in contact with the housing 13. Even if not provided for in the design shown, the supporting arms can also serve as welding points. The other functions of the supporting arms 23 are described below.

FIG. 2 shows a longitudinal section of the photoelectric sensor partial region shown in FIG. 1. The hollow cylindrical housing 13 forms the outer boundary of the sensor 11. The optical module 15 is arranged in it, which, among other things, comprises the supporting body 17. A printed circuit board 19 is arranged along one side of the supporting body 17, with the transmitting or receiving elements 29 of the photoelectric sensor 11 being arranged on it. The beams from the transmitting and receiving elements 29 must pass through the supporting body 17. For this purpose, continuous recesses 31 are provided in the supporting body 17 at the level of the transmitting or receiving elements. A lens assembly 21 is arranged at the end of the recess 31 opposite the transmitting or receiving elements 29. The lens assembly 21 is attached to the supporting body 17 by means of the aperture assembly 22, which serves as an aperture for the lens assembly 21 and ensures a desired resolution of the light curtain. The aperture assembly 22 has a plate-shaped structure with positioning lugs 28 that project vertically from one flat side. The supporting body 17 has recesses to accommodate the positioning lugs 28 of the aperture assembly 22. The positioning lugs 28 and the recesses in the supporting body 17 are dimensioned in such a way that when the positioning lugs 28 are inserted into the recesses, a frictional connection is created between the supporting body 17 and the aperture assembly 22. The length of the aperture assembly 22 may differ from that of the supporting body 17. It is possible that several aperture assemblies 22 are arranged on one supporting body 17.

The hollow cylindrical housing 13 has an opening 32 at each of its longitudinal ends. These openings can each be closed with an end cap 27. In FIG. 2, the opening 32 of the hollow cylindrical housing 13 is closed by an end cap 27. The end cap 27 extends with a first region 33 through the opening into the hollow cylinder, so that this region is in contact with the inside of the housing wall. The second region 34 of the end cap 27, which is located outside the housing 13, is attached to the longitudinal end of the housing so that the end cap 27 and the housing 13 have an annular contact surface. The contact surface in the first region 33 can serve as a welding point. The cylindrical surface as a contact surface in the first region 33 between the end cap 27 and the housing 13 enables the use of laser beams directed perpendicular to the housing 13 for laser welding. The contact surface in the second region 34, on the other hand, requires the use of laser beams directed at an acute angle to the housing wall for laser welding. By rotating the laser beam source or the housing 13 around its center axis, a continuous welded connection can be created between the housing 13 and the end cap 27 in a single step.

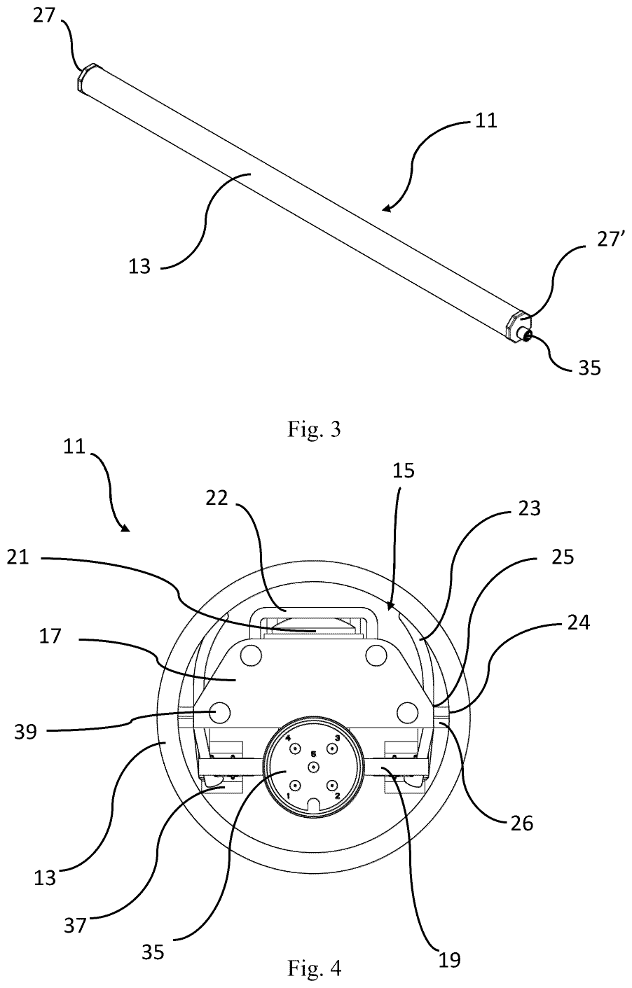

FIG. 3 shows a photoelectric sensor 11 in its entirety. The housing 13 of the photoelectric sensor is cylindrical. The optical modules are arranged inside the housing 13 and are not shown in this figure. End caps 27 are attached to both ends of the cylindrical housing 13. One of the end caps 27′has an opening for a connector 35. The connector 35 forms the interface with another electrical device, so that the information of the photoelectric sensor 11 can be transmitted via the connector 35, for example, to a control unit attached to it. At the same time, the information of the optical module 15 adjacent to the end cap 27 is transmitted via its printed circuit board 19 to the connector 35. The end caps 27 completely cover the surface at the ends of the cylindrical housing 13. The part of the end caps 27 that protrudes above the housing 13 is designed as an octagonal nut. Among other things, this allows for a better overview of the position of the end caps and optical modules and prevents the light curtain from rolling away.

FIG. 4 is a view of the face of a photoelectric sensor 11, showing the connector 35 but not the end cap. The optical module 15 is placed inside the cylindrical housing 13. The optical module 15 is in contact with the housing 13 via the projections 26 on the longitudinal sides 25 and via the supporting arms 23. In the cross-section shown in FIG. 4, there are four contact points between the optical module 15 and the housing 13, wherein in the design shown, only the projections 26 of the optical module are intended to be welded. Supporting arms 23 are used to position the optical module 15 within the housing 13 until a welded connection is made. The distance between the opposing projections 26 is slightly larger than the inner diameter of the housing 13, so that an interference fit is formed between the optical module 15 and the housing 13. Supporting arms 23 are approximately perpendicular to the plane formed by the opposing projections 26 and, through contact with the housing, cause a force in the opposite direction. (?) Even though this force is very small, it helps to fix the optical module 15 in the housing 13 until the welded connection is made.

One or several printed circuit boards 19 are held in a form-fitting manner in the optical module 15. When using more than one printed circuit board 19, the electrical connection between adjacent printed circuit boards 19 is made via connecting plugs 37. These are intended to be attached to the printed circuit boards 19.

The optical module 15 has a plug 39 at one of its ends and sockets at the other, which together create a plug-socket connection. This means that the size and location of the plugs and sockets is chosen so that the plugs 39 of an optics module 15 can be inserted into the sockets of another optics module. The sockets are arranged at the same height and width as the plugs 39. This connection prevents any twisting of the optical modules relative to each other and ensures that after two optical modules 15 have been connected, the transmitters or receivers of all 15 optical modules are aligned in the same direction.

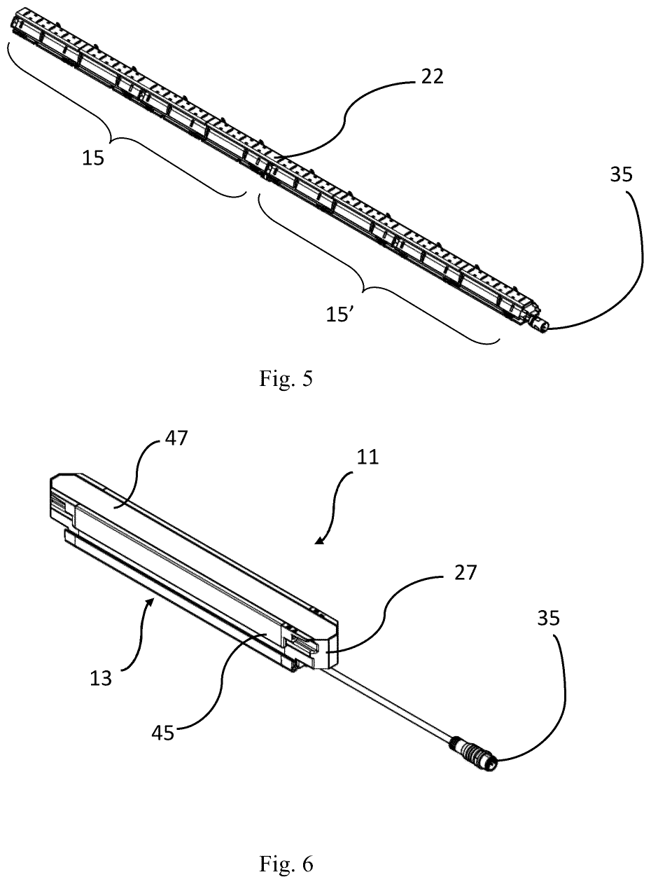

FIG. 5 shows two interconnected optical modules 15, 15′. In the embodiment shown here, the printed circuit boards 19 are arranged on one longitudinal side of the supporting bodies 17, 17′, while lens assemblies 21 are arranged on the opposite longitudinal side of the supporting bodies 17, 17′. The aperture assembly 22 is mounted on that side of optical module 15 on which lens assemblies 21 are arranged. The aperture assemblies 22 are designed to be attached to the optical modules 15 in such a way that a continuous aperture assembly 22 is arranged at the transition between two optical modules 15. Thus, the aperture assembly 22, arranged on two optical modules 15, 15′, ensures that the resolution is also identical across the modules. During assembly, the optical modules 15 are joined together in a first step via their plug-and-socket connection, so that the transmitters or receivers of the optical modules 15 are immediately aligned. To do this, the plugs 39 of an initial optical module 15 are inserted into the socket of the second optical module. In a second step, the aperture assemblies 22 are attached to the optical modules so that the optical modules 15, lined up next to each other, are connected to form a strand of optical modules. The neighboring printed circuit boards 19 are connected to each other by connecting plugs 37. The connecting plugs form the electronic connection between two printed circuit boards 19. As an alternative to the embodiment shown in FIG. 5, it is also conceivable that an aperture assembly is not arranged on two supporting bodies, but rather that a new aperture assembly is arranged at the transition from one supporting body to the adjacent supporting body.

FIG. 6 shows a further embodiment of a photoelectric sensor according to the invention. In contrast to the previously shown design, the housing 13 has a rectangular cross-section instead of a round one. The housing 13 is formed from a U-profile 45 and a protective screen 47, wherein the protective screen 47 is arranged on the U-profile 45 in such a way that it closes the opening of the U-profile. The optical module is placed in the housing 13. The optical module 15 can be attached to both the U-profile 45 and the protective screen 47 of the housing.

End caps 27 are also provided to close the openings at both ends of the housing 13 shown here. The end cap 27 has a shape corresponding to the cross-section of the U-profile 45 and can be arranged adjacent to the respective openings of the U-profile 45.

While specific embodiments have been described above, it is obvious that different combinations of the embodiments shown may be used, provided the embodiments are not mutually exclusive.

### LIST OF REFERENCE SYMBOLS

11 Photoelectric sensor
13 Housing
15 Optical Module
17 Supporting body
19 Printed circuit board
21 Lens assembly
22 Aperture assembly
23 Supporting arms
24 Contact points
25 Longitudinal sides
26 Projections
27 End caps
28 Positioning lugs
29 Transmitting or receiving element
31 Continuous recess on the supporting body
32 Opening at the longitudinal end of the housing
33 Contact surface in the first region
34 Contact surface in the second region
35 Connector
37 Connecting plug of the printed circuit board
39 Plug
45 U-profile
47 Protective screen

1.-31. (canceled)

32. A photoelectric sensor, in particular a light curtain, comprising:
an elongated housing and
an optical module which is arranged in the housing, wherein
transmitting and/or receiving elements are arranged at the optical module at a distance from one another,
the optics module is connected to the housing via contact points, and
the optical module and the housing comprise plastic,
wherein
at least some of the contact points between the optics module and the housing are designed as welded connections and the welded connection between the housing and the optics module is formed by laser transmission welding.

33. The photoelectric sensor according to claim 32, wherein that at least in the region of the contact points to be designed as welded connections, either the housing is transparent to infrared rays and the optics module absorbs infrared rays, or the housing absorbs infrared rays and the optics module is transparent to infrared rays.

34. The photoelectric sensor according to claim 32, wherein the contact points of the optics module and of the housing each comprise a mutually compatible plastic.

35. The photoelectric sensor according to claim 32, wherein an infrared-ray-absorbing additive is added to the plastic material of at least one of the two components at the intended contact points of the optics module with the housing.

36. The photoelectric sensor according to claim 32, wherein the optics module comprises a supporting body on which a printed circuit board with the transmitting or receiving elements is arranged.

37. The photoelectric sensor according to claim 36, wherein the supporting body and the housing are made of a compatible thermoplastic material and the welded connections are made between the housing and the supporting body.

38. The photoelectric sensor according to claim 36, wherein lens and/or aperture assemblies are provided on the supporting body opposite the transmitting or receiving elements.

39. The photoelectric sensor according to claim 36, wherein at least the supporting body and the housing are made of polycarbonate.

40. The photoelectric sensor according to claim 32, wherein the housing has a cylindrical shape.

41. The photoelectric sensor according to claim 32, wherein the housing comprises an elongated base body forming a receiving space for the optics module, with at least one opening on a longitudinal side and with a protective screen closing at least this opening.

42. The photoelectric sensor according to claim 41, wherein the protective screen is welded at the edge to the base body.

43. The photoelectric sensor according to claim 42, wherein the welded connection between the base body and the protective screen forms a connection that is sealed against spray water.

44. The photoelectric sensor according to claim 32, wherein end caps are attached to both open longitudinal ends of the housing, wherein the end caps are at least partially made of an infrared-ray-absorbing plastic.

45. The photoelectric sensor according to claim 44, wherein the end caps are attached to the housing and/or to the optics module by means of laser transmission welding.

46. The photoelectric sensor according to claim 32, wherein two or more optical modules can be connected to one another on the front side.

47. The photoelectric sensor according to claim 32, wherein the transmitting and/or receiving elements of all the optical modules in the housing are directed in the same radial direction of the cylindrical housing.

48. The photoelectric sensor according to claim 32, wherein the optics module has a first plug-in connection at its one longitudinal end and a second plug-in connection at its opposite longitudinal end, it being possible for the first and second plug-in connections to be coupled to one another.

49. The photoelectric sensor according to claim 48, wherein the end cap has a plug-in connection which can be coupled to the plug-in connection of the terminal optical module.

50. A method for producing a photoelectric sensor comprising an elongate housing and an optical module arranged in the housing, the method comprising:
transmitting and/or receiving elements being arranged on the optical module,
the optical module being inserted into the housing and
aligned therein,
wherein
the optical module is connected to the housing by laser transmission welding.

51. The method according to claim 50, wherein the optical module is inserted through an open longitudinal end of the housing, the open longitudinal end is closed with an end cap after the optical module has been inserted, the end cap is welded to the housing or the optical module by means of laser transmission welding.

52. The method according to claim 50, wherein the optics module comprises supporting arms which, upon insertion into the housing, are in contact with the housing and center the optics module in the housing.
